(19) United States
(12) Patent Application Publication
(10) Pub. No.: US 2006/0001656 A1
(43) Pub. Date: Jan. 5, 2006

(54) Electronic ink system

(76) Inventors: Joseph J. LaViola JR., Providence, RI (US); Robert C. Zeleznik, Barrington, RI (US); Timothy Miller, Providence, RI (US); Loring Holden, Providence, RI (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 11/175,079

(22) Filed: Jul. 5, 2005

Related U.S. Application Data
(60) Provisional application No. 60/585,297, filed on Jul. 2, 2004.

(51) Int. Cl. G09G 5/00

(52) U.S. Cl. 345/179

(57) ABSTRACT

In a system that enables a user to gesturally input electronic ink on an input surface, a method of inputting a gesture command distinguishable from other marks includes inputting gesture command sequences on an input surface. In some embodiments, the gesture sequence includes forming a terminal gesture mark to instruct the system to perform an action.

### RELATED APPLICATIONS

This application claims priority under 35 U.S.C. § 119(e) to U.S. Provisional Application Ser. No. 60/585,297, entitled “Electronic Ink System,” filed on Jul. 2, 2004, which is herein incorporated by reference in its entirety.

### RELATED ART

1. Field of Invention

The invention relates generally to electronic ink marks and gesture commands. More specifically, the invention relates to modelessly combining marking and gesturing in an electronic ink system.

2. Discussion of Related Art

The theoretical potential of pen-based computers stems from the notion that pen-based interactions can be more closely tailored, in many cases, to human capabilities then their computationally equivalent, or even more powerful, mouse-based counterparts. Informally, when human and computing abilities are closely matched, the resulting interfaces feel fluid—users can focus on the problem and not on extrinsic user interface activities. User-friendly interfaces are important for free-form note-taking because of note-taking's dependence on rapid, natural notational entry and manipulation. One of the advantages of an electronic note-taking system is the ability to manipulate notes by inputting commands. Distinguishing commands from notational entries (e.g., ink marks), however, presents a problem.

Various approaches for incorporating gesture commands into a note-taking environment have been used. For purposes herein, the term “gesture command” means a gestural input that instructs a system to perform a function other than only displaying the gesture mark or marks that are made with the gestural input. In other words, many gesture marks are displayed such that the resulting marks correspond to the gesture movements used to make the marks, while some gesture marks are recognized to be a gesture command primitive and/or a gesture command that instructs the system to perform a function.

Many of these approaches aim to define the set of gesture commands so as to limit the restrictions that these commands place on the kinds of ink marks that can be drawn. For instance, some systems pre-define certain types of ink marks as gesture commands. Many of these approaches have included the use of pen modes to disambiguate gesture commands from ink marks. The use of modes typically expects a user to be vigilant as to which mode is selected at any given time. For example, some systems require that a button (on the pen or elsewhere) be pressed prior to inputting a gesture command to distinguish a gesture command from other types of ink marks (e.g., notes). Other approaches use a modeless gestural user interface, but include restrictions on the type of ink marks that can be accepted.

Methods of resolving ambiguity in systems that include handwriting-based interfaces have also been investigated. However, such a method implies that there are certain ink marks that are only capable of being interpreted as gestures rather than free-form notes.

A need therefore exists for a system that conveniently incorporates gesture commands into a free-form note taking environment, while limiting the restrictions on types of notes that may be written.

### SUMMARY OF INVENTION

According to one embodiment of the invention, in a system that enables a user to gesturally input electronic ink on an input surface, a method of inputting gesture commands distinguishable from other marks comprises forming a context specification gesture mark on the input surface to define a context for the gesture command, forming an action gesture mark on the input surface to indicate an action for the gesture command, and forming a terminal gesture mark on the input surface to command the system to perform the action, the terminal gesture mark being a single gesture mark.

According to another embodiment of the invention, in a system that enables a user to gesturally input electronic ink on an input surface, a method of inputting a gesture command distinguishable from other marks comprises forming a scribble gesture mark on the input surface to define a context for the gesture command, and forming a terminal gesture mark on the input surface to instruct the system to delete marks present in the context.

According to a further embodiment of the invention, in a system that enables a user to gesturally input electronic ink on an input surface, a method of inputting a gesture command distinguishable from other marks comprises, in a first mode, forming an action gesture mark on the input surface to indicate a set of actions, and, in the first mode, forming a terminal gesture mark on the input surface to command the system to perform one action of the set of actions. In this embodiment, the location of the terminal gesture mark on the input surface relative to one of the action gesture mark and a context specification gesture mark designates the one action of the set of actions.

According to another embodiment of the invention, a computer-readable medium has computer-readable signals stored thereon that define instructions that, as a result of being executed by a computer, instruct the computer to perform a method that enables a user to gesturally input, on an input surface, a gesture command distinguishable from other types of electronic ink, the method comprising acts of receiving a context specification gesture mark that defines a context for the gesture command, receiving an action gesture mark that indicates an action for the gesture command, and receiving a terminal gesture mark that commands the computer to perform the action, the terminal gesture mark comprising a single gesture mark.

According to a further embodiment of the invention, a computer-readable medium has computer-readable signals stored thereon that define instructions that, as a result of being executed by a computer, instruct the computer to perform a method that enables a user to gesturally input, on an input surface, a gesture command distinguishable from other types of electronic ink, the method comprising acts of receiving a scribble gesture mark that defines a context for the gesture command, and receiving a terminal gesture mark that commands the computer to delete marks present in the context.

According to another embodiment of the invention, a computer-readable medium has computer-readable signals stored thereon that define instructions that, as a result of being executed by a computer, instruct the computer to perform a method that enables a user to gesturally input, on an input surface, a gesture command distinguishable from other types of electronic ink, the method comprising acts of, in a first mode, receiving an action gesture mark that indicates a set of actions, and, in the first mode, receiving a terminal gesture mark that commands the computer to perform one action of the set of actions. In this embodiment, the location of the terminal gesture mark on the input surface relative to one of the action gesture mark and a context specification gesture mark designates the one action of the set of actions.

According to yet another embodiment of the invention, a computer-readable medium has computer-readable signals stored thereon that define instructions that, as a result of being executed by a computer, instruct the computer to perform a method that enables a user to gesturally input, on an input surface, a gesture command distinguishable from other types of electronic ink, the method comprising acts of receiving an action gesture mark that indicates an action for the gesture command, and receiving a terminal gesture mark, wherein a first type of terminal gesture mark puts the gesture command into a user-interactive mode, and a second type of terminal gesture mark puts the gesture command into a non-user-interactive mode.

### BRIEF DESCRIPTION OF DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For the purposes of clarity, not every component is labeled in every figure, nor is every component of each embodiment of the invention shown where illustration is not necessary to allow those of ordinary skill in the art to understand the invention.

In the figures:

FIG. 1 illustrates a block diagram of an example of an electronic ink system according to one embodiment of the invention;

FIG. 2 illustrates an example of a display screen displaying a set of handwritten notes and gesture commands according to one embodiment of the invention;

FIG. 3 is a table showing one embodiment of a set of gesture command primitives and gesture command sequences;

FIG. 4 illustrates one example of a scribble-erase gesture command;

FIG. 5 illustrates another example of a scribble-erase gesture command;

FIG. 6 is a flowchart illustrating an example of a method of inputting a gesture command to an electronic ink system; and

FIG. 7 shows a block diagram of one embodiment of a general purpose computer system.

### DETAILED DESCRIPTION

This invention is not limited in its application to the details of construction and the arrangement of components set forth in the following description or illustrated in the drawings. The invention is capable of other embodiments and of being practiced or of being carried out in various ways.

Definitions

As used herein, the terms “mark” and “ink mark” mean any complete or partial symbol, sign, number, dot, line, curve, character, text, drawing, image, picture, or stroke that is made, recorded, and/or displayed.

As used herein, the term “gestural input” means an input that is provided to a system by a user through the use of handwriting, a hand movement, or a body movement, including, for example, the use of a stylus on a digitizing surface or other touch-sensitive screen, a finger on a touch-sensitive screen, a light pen, a track ball, and a computer mouse, among others. Gestural inputs are not intended to mean selections of drawing primitives or alphanumeric codes from menus, or the use of keyboards, selection pads, etc., although such inputs may be used in combination with gestural inputs in some embodiments.

As used herein, the term “gesture mark” means any complete or partial symbol, sign, number, dot, line, curve, character, text, drawing, or stroke that is recorded from human movement. A display of the mark corresponding to the movements of the human in making the gesture may be shown during and or after the movement. For example, gesture marks may be made with the use of a stylus on a digitizing surface. In another example, a computer mouse may be used to form gesture marks.

As used herein, the term “flick gesture mark” means an individual gesture mark drawn rapidly and intended by the user to be substantially straight.

As used herein, the term “gesture command primitive” means an individual gesture mark that, either alone or in combination with other gesture command primitives, specifies performance of, defines, or indicates a portion or all of a gesture command.

As used herein, the term “context specification gesture mark” means one or more gesture marks that specifies a certain area of a display or specifies certain marks or types of marks.

As used herein, the term “electronic ink” means the digital information representing handwriting or other marks recognized, recorded or displayed by/on a computer.

As used herein, the term “mode” means a state of a system in which the system is configured to receive a certain type of input and/or provide a certain type of output.

As used herein, the term “input surface” means a surface that receives or accepts input from a user.

As used herein, the term “notes” refers to a collection of marks (e.g., text, drawings, punctuation marks, punctuation marks, strokes, etc.), representing information, made by a human on an input surface, such as a recording surface a digitizing surface, a touch-sensitive screen, a piece of paper, or any other suitable recording surface.

As used herein, the terms “stroke” and “ink stroke” mean a mark that includes a line and/or a curve. An ink stroke may be a line of darkened pixels formed or displayed on a digitizing surface. Another example is a curve formed on a piece of paper with a regular ink pen.

As used herein, the term “lasso” means an ink stroke or mark, or a set of ink strokes or marks that partially or completely encloses one or more ink marks.

As used herein, the term “terminal mark” means a mark that can signal an end to a sequence or a request to perform an action. Examples of a terminal mark include a tap, a tap-pause, a double-tap, a triple-tap, and a pause at the end of a gesture primitive.

Electronic Ink System

According to some embodiments of the invention, a system enables a user to gesturally input commands to a system without significantly restricting the types of marks that the user may input as notes or other information. In one embodiment, the system enables a user to take notes (e.g., text and drawings) on a tablet computer using a stylus, pen or other writing implement and, without changing modes, to input commands to the system using the same writing implement.

According to some embodiments of the invention, a gesture command is a sequence of drawn electronic ink marks that is collectively distinct from conventional notes even though the individual ink marks of the sequence may be identical to conventional marks made during typical note-taking. For example, in one embodiment a gesture command includes forming a scribble mark across some notes on a digital recording surface, and then tapping the surface as if writing a period. This short sequence of ink marks may instruct the system to delete the notes selected by the scribble mark. As another example, a gesture command includes forming a flick gesture mark diagonally up and to the right and then writing a gesture mark that overlaps the flick gesture mark. In other embodiments, there might be no restriction on the direction of the flick gesture mark, or the direction of the flick gesture mark might indicate an additional parameter. In still other embodiments, the overlapping gesture mark may be an alpha-numeric character that is mnemonically associated with the gesture command. In still other embodiments, the overlapping requirement may be omitted.

By not requiring a user to select a mode prior to inputting a command, the user is better able to seamlessly write notes and provide commands to the system. Without a change in modes, however, the system distinguishes commands from notes in a different manner. An attempt to distinguish single, ink-mark gesture commands from single, ink-mark notes may limit the types of marks eligible to be used for notes. Specifically, gesture marks assigned to certain gesture commands may not be available to the user for general note-taking, absent an indication by the user that he or she is writing notes rather than inputting a command. According to some embodiments of the invention, this problem is avoided by using a sequence of marks to indicate a gesture command. For example, in some embodiments, a delete command sequence including a scribble and a tap does not restrict the user from marking a scribble in their notes, provided that the next gestural action is not a tap. In this manner, the user does not select modes to distinguish gesture commands from gestural note-taking, rather, the user provides a short sequence of gesture marks to input a command.

Systems incorporating some or all of the above features may be useful in applications that include the manipulation of electronic ink. For example, such a system may be used for entering and manipulating mathematical expressions and/or drawing elements.

According to some embodiments of the invention, gesture commands are defined such that feedback from the system as to whether notes or commands are being received is not required for a user to both take notes and enter commands. In other words, the system may not provide signals to the user regarding whether a command is being received or notes are being received. In some embodiments, confirmation that a command has been performed may be provided by the system, for example with an audio or visual signal. The system also may not provide displays of options for commands (e.g., pop-up menus) each time the user indicates the entry of a command, although in some embodiments, pop-up menus or other interactive displays may be requested or automatically generated. In some embodiments, gesture commands also may not require fine targeting of a stylus or other writing implement in that selections of commands may not be made from lists or buttons. Combinations of various aspects of the invention provide a modeless pen-based system that closely matches the interfaces of a common paper-and-pencil environment.

One embodiment of an electronic ink system is presented below including one example of a gesture set for use as commands. It is important to note that this embodiment and these gesture commands are presented as examples only, and any suitable gesture set may be used.

In the following description, each embodiment of the invention may optionally provide the user with assistance in discovering and remembering the gesture set by displaying an iconic, shorthand, or animated representation or description of one or more gesture commands as part of the system menu items, thereby providing a second method of access to similar or the same command operations.

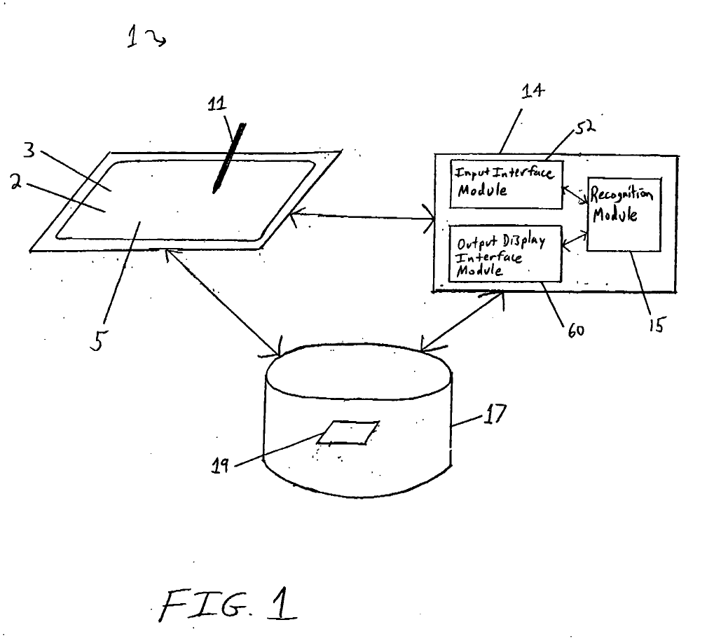

FIG. 1 illustrates a block diagram of an embodiment of an electronic ink system 1 according to one embodiment of the invention. An input/output device 2, including a display screen 3 and a digitizing surface 5 (which may be associated with a tablet computer), may be operatively connected with an electronic ink engine module 14 and a database 17. Digitizing surface 5 may be configured to receive input from a stylus 11 in the form of handwritten marks. Information representing these inputs may be stored in database 17, for example, in one or more mark data structures 19.

In the embodiment illustrated in FIG. 1, system 1 may record and display electronic ink and receive gesture commands. Electronic ink engine module 14 may include any of a user input interface module 52, a recognition module 15, and an output display interface module 60. Functions and/or structures of the modules are described below, but it should be appreciated that the functions and structures may be dispersed across two or more modules, and each module does not necessarily have to perform every function described.

User input interface module 52 may receive inputs from any of a variety of types of user input devices, for example, a keyboard, a mouse, a trackball, a touch screen, a pen, a stylus, a light pen, an digital ink collecting pen, a digitized surface, an input surface, a microphone, other types of user input devices, or any combination thereof. The form of the input in each instance may vary depending on the type of input device from which the interface module 52 receives the input. In some embodiments, inputs may be received in the form of ink marks (e.g., from a digitized surface), while in other embodiments some pre-processing of a user's handwriting or other gestural inputs may occur. User input interface module 52 may receive inputs from one or more sources. For example, ink marks may be received from a digitized surface (e.g., of a tablet computer) while other text may be received from a keyboard.

Recognition module 15 may be configured to recognize gesture command primitives. In some embodiments, gesture command primitives include a lasso, a strokehook, a tap, a scribble, a crop mark, and other primitives. One example of a set of primitives (see “Gesture Set” Section) and details of one embodiment of a primitives-recognition algorithm (see “Primitive Recognition Overview” and “Primitive Recognition Details” Sections) are described below.

In some embodiments, with the exception of terminal gesture marks, recognition module 15 attempts to recognize ink marks as gesture command primitives retroactively, for example, after recognizing a terminal gesture mark. For example, after recognizing a tap mark as a terminal gesture mark, recognition module 15 may attempt to recognize ink marks that were entered immediately preceding the tap. If the preceding marks are recognized as gesture command primitives, and the sequence of primitives matches a pre-defined gesture command sequence, module 15 may instruct system 1 to perform the operation specified by the gesture command sequence.

In some embodiments, a terminal gesture mark may be input at the end of a gesture command sequence. In other embodiments, a terminal gesture mark may be input at a position in the sequence other than the end of the sequence. The position assigned to a terminal gesture within a sequence may depend on the gesture command being entered. For example, in one gesture command set, a terminal gesture mark may be assigned a position at the end of the sequence for some gesture commands, and during the sequence for other gesture commands.

In some embodiments, recognition module 15 may recognize the location of a terminal gesture mark on an input surface as part of recognizing the type of gesture command being entered. For example, a sequence comprising a primitive and a tap at a first location relative to the primitive may specify a first type of gesture command, while a sequence comprising a primitive and a tap at a second location relative to the primitive may specify a second type of gesture command.

Based on results provided by recognition module 15, electronic ink engine module 14 may provide information and/or instructions to input/output device 2 via output display interface module 60. Input/output device 2 may have an output display that partially or entirely overlaps with an input surface. For example, a display screen overlaid with a digitizing surface (e.g., as part of a tablet computer) may be used as input/output device 2. Other output displays are contemplated, such as three-dimensional displays, or any other suitable display devices. The system may be configured to provide audio output as well, for example, in conjunction with the display.

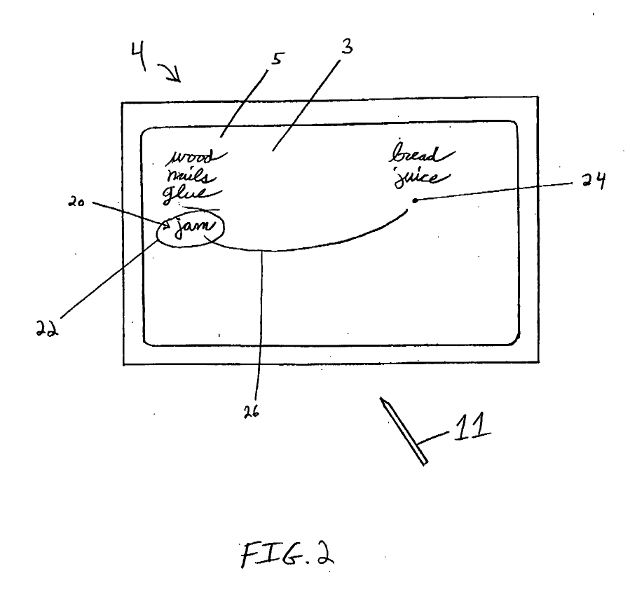

FIG. 2 illustrates an example of display screen 3 (e.g., as part of a tablet computer 4) displaying a set of handwritten notes and gesture commands according to one embodiment of the invention. Display screen 3 includes two lists of words, a word 20 (initially a member of a first of the lists), an enclosing ink mark 22, and a tap mark 24. The handwritten text may appear as written by a user, or system 1 may attempt to recognize the content of the handwriting (e.g., by accessing samples of the user's handwriting) and display the text using samples of the user's own handwriting, thereby providing feedback as to how system 1 is recognizing the ink marks.

After the user has written on digitizing surface 5 (e.g., written words, drawings, or any other ink mark), the user may specify actions for system 1 to perform by forming gesture commands on digitizing surface 5. In some embodiments, gesture commands take the form of short sequences of ink marks. For example, as shown in FIG. 2, to move a word from one location on display 3 to another location, the user may: (1) lasso the word with enclosing ink mark 22; (2) write an ink stroke 26 which starts inside the lasso and ends outside the lasso; and (3) complete the sequence with a terminal mark, such as tap 24. In response to the sequence, system 1 moves the display of word 20 to the tap location (i.e., the bottom of the second list).

The movement of the word from the first list to the second list may be displayed any of a variety of ways. For example, the word may disappear from its first location and re-appear at the second location. In another example, the word could be shown traveling along a straight line to its second location, or, in other examples, the word could follow the path specified by stroke 26.

To form the ink marks on digitizing surface 5, the user may use a stylus, pen, a finger, or any other suitable writing implement. In some embodiments, the writing implement need not directly contact digitizing surface 5 to interact with the input surface. Any of a variety of types of input surfaces and writing implements may be used to form ink marks for inputting notes or inputting gesture commands, as the specific types described herein are not intended to be limiting.

By using sequences of ink marks to specify a gesture command, individual ink marks or ink strokes that form a subset of a sequence may still be used for conventional note-taking. For example, if tap 24 is not entered at the end of the gesture command sequence described for the example in FIG. 2, enclosing ink mark 22 and/or stroke 26 may be recognized as notes instead of as gesture commands. In this manner, the restrictions on the types of notes that may be written are limited to restrictions on particular sequences, rather than restrictions on individual marks or strokes.

Gesture Sequence Commands

Specific details for one embodiment of gesture primitives and gesture sequences are described below. These details are provided as examples only, and other suitable gesture primitives and/or gesture sequences may be used.

Gesture Set

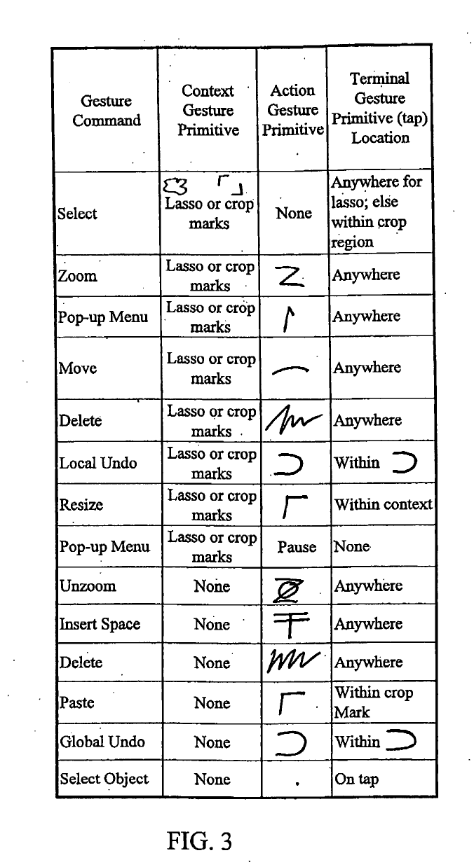

FIG. 3 includes a table showing one example of a gesture set. The information contained in this table may be stored in one or more data structures in database 17. In one embodiment, a gesture set includes the following primitives: a stroke; a strokehook; a lasso; a tap; a crop; a scribble; a “⊃”; and a “Z”. The first column lists various commands that may be entered with the gesture sequences shown. The second column lists context gesture primitives available for specifying a context. The third column shows various examples of action gestures that may be used to indicate a specific type of action. The fourth column describes the location of a tap, the tap being used as a terminal gesture to command the system to perform the indicated action.

In one embodiment, many of the gesture commands comprise either two or three parts. Common to each command is an action gesture and a punctuation gesture. Some of the gesture commands also include a context specification gesture. For example, a context specification gesture may be two crop marks or a lasso. Crop marks may be used to specify a rectangular region, while the lasso may indicate a region of more arbitrary shape. Feedback (e.g., highlighting of a region) may not immediately be provided in response to the context being drawn so that the user is not distracted when drawing similar marks while taking normal notes (i.e., the user is not attempting to enter a gesturally-based command). Further, a user typically inputs commands at a speed that does not leave time for the user to respond to any feedback. Of course, in other embodiments, various feedback could be provided after certain gestures have been entered.

In some embodiments, the terminal gestures are punctuation gestures comprising a single tap of stylus 11 or a tap-pause or a pause with stylus 11 held down at the end of the previous primitive gesture. In some embodiments, punctuation may be any independent ink mark or any ink mark or action that is a continuation of the previous primitive gesture. For purposes herein, a “continuation” means an ink mark that is made or action that is performed without lifting the gesturing implement (such as a stylus). For example, a scribble mark, a pause action or a flick gesture mark could be input as a continuation of the previous primitive gesture, or could be input as a separate ink mark. Different forms of punctuation may indicate different function parameters. For example, a tap may indicate a non-interactive command, while a pause or a tap-pause may indicate an interactive version of the same command.

In some embodiments, a context specification gesture is a separate ink mark. In other embodiments, a continuation may follow a context specification gesture, that is, a next gesture primitive may be formed without lifting the stylus from the context specification gesture. In some embodiments, a flick gesture or a tap gesture may be used as a context specification gesture.

Primitive Recognition Overview

When the system is prompted to attempt to recognize a mark as a gesture command primitive, the mark is recognized as a “stroke” primitive unless the mark matches one of the other primitives. The third columns of the table in FIG. 3 show one illustrative embodiment of a set of gesture primitives. A “stroke” may be a line or curve that the user uses to indicate a location to which to move specified ink marks. A “strokehook” is a mark which partly doubles back on itself at the end. A “lasso” is a closed or nearly closed mark of a predefined sufficient size. A “tap” is a quick tap of the stylus. A “crop” is any of four axis-aligned crop marks. A “scribble” is a scratch-out gesture, e.g., a back and forth scribbling action. The “⊃” primitive is drawn from bottom to top. In some embodiments, a pause, as a terminal gesture, includes pausing the stylus in place at the end of a previous gesture primitive. In some embodiments, a pause, as a terminal gesture, includes pausing the stylus in place during a tap.

Context Specification

As described above, context for an action may be specified to be a rectangular region or a region of more arbitrary shape. A rectangular region is specified with two oppositely-oriented crop marks, while a region of more arbitrary space may be specified with a lasso (see the second column of the table in FIG. 3). The context specification gesture may be combined with an action gesture and a terminal gesture to form a gesture command sequence. To prevent conflicts with normal note-taking, a gesture sequence is recognized if the context encloses at least one mark. There may be some gesture sequences that are recognized even if the context does not enclose at least one mark. For example, the “zoom” gesture sequence, shown by way of example in the table in FIG. 3, is recognized even if no mark is enclosed.

Actions Using Context

Five operations that may use context have specific gesture sequences: move, resize, local undo, zoom in, and delete. Other operations may be accessed through a gesture that elicits a menu. These gestures may include terminal gestures of a tap to invoke a non-interactive version of the operation or a pause to invoke an interactive version of the operation.

The “stroke” gesture in the “move” gesture sequence may be set to have a minimum length to avoid being recognized as a “tap.” Thus, attempting to move the contents of a context only a small distance may not be recognized. Accordingly, one may move the contents of the context a further distance and then move them a second time back to the target location. To support small distance moves more cleanly, a pop-up menu may include a “move” entry that enables moves of any distance, including small distances.

The “local undo” gesture sequence applies to changes made to marks within the context. Each change made to each mark is ordered by time and undone or redone separately. For a single “local undo” action, “⊃” is formed and a tap is marked inside the “⊃” To perform multiple undo or redo actions, the “⊃” gesture may be formed, and then short right to left strokes starting inside the “⊃” undo further back in history. Short left to right strokes also may be started within the “⊃” to perform a redo action. Unlike other gesture sequences, if the “⊃” gesture is formed, terminal gestures of short left to right strokes or short right to left strokes do not cause the “⊃” mark to disappear.

The user may zoom in on a specified region by indicating the region as context and then forming a “Z” inside the context, and then forming a tap. The system may be configured to zoom so that the bounding-box of the context fills the available display space as much as possible.

Scribbling over a context may delete all marks contained within the context. Defining “over the context” can take several different forms. One simple variant is requiring that the scribble's bounding box include the context's bounding box. Bounding boxes can often be perceptually difficult to gauge or physically tedious to specify, especially when dealing with irregular shapes. Another variant is to require a scribble that starts outside the specified context and then deletes any mark that the stylus touches until the stylus is lifted. In another embodiment, the size and shape of the context may be used as an eraser.

Some gestures may use a context specification gesture to indicate the start of a gesture command. For example, a mnemonic flick gesture may use a flick gesture that is input first to specify a context, with the flick gesture being followed by the input of one or more alpha-numeric gestures to mnemonically indicate a function. In some embodiments, terminal punctuation may be input to distinguish the end of the gesture command. In some embodiments, the context gesture and the next gesture primitive may both be part of the same ink mark. The context can be distinguished from the next primitive by recognizing a pause in the input or by recognizing a cusp or other attribute of the ink mark.

Actions Not Using Context

Some gesture sequences do not use a context specification gesture. These gesture sequences are performed outside any existing selection (e.g., lasso or crop marks) and they may include terminal gestures to invoke the interactive version. Gesture sequences that do not include the use of a previously specified context include: unzoom, insert space, delete, paste, global undo, and select object.

A lasso, followed by a “Z” whose bounding-box encloses the lasso, followed by a tap, causes the system to zoom out to the previous zoom level in the zoom history of the working document. The lasso is not used to denote context in this gesture.

The “insert space” gesture sequence enables space to be added in any direction. Further, the line marking where space should be inserted may be curved. In this embodiment, the gesture sequence begins with the drawing of an arbitrary, unclosed, non-self-intersecting line to indicate a dividing line. A second mark is then drawn to closely follow the first line, but in the reverse direction. The criteria for recognizing the marks as an insert space command include that the total area between the marks is small, i.e., a certain percentage, compared to the square of the sum of the lengths of the two lines. Another criteria is that the start of the second line is closer to the end of the first line than the start-of the second line is to the start of the first line. After the two lines have been drawn, the user draws a relatively straight mark crossing the first two lines to indicate the direction and quantity of space to be added or removed. The end points of the first line are extended to infinity along the direction of the final “straight” line to determine the region affected.

The terminal gesture may include a tap or a pause to indicate the non-interactive and interactive versions, respectively.

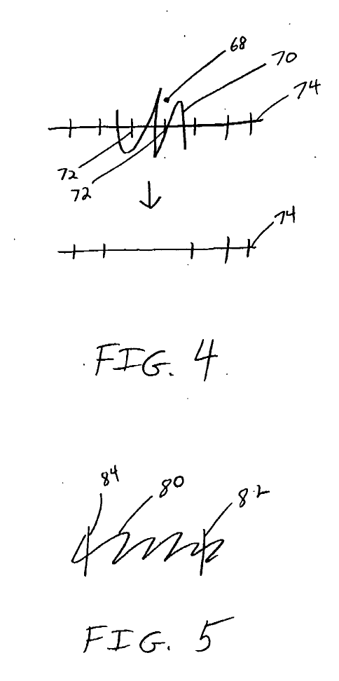

A version of a delete operation that includes the use of a context is described above. A delete operation may also be defined that does not use a context. In the illustrative embodiment, the non-interactive version of a delete operation has two subversions—a “wide delete” and a “narrow delete.” If the terminating gesture is located outside of a scribble gesture, the gesture sequence is recognized as a wide delete. If the terminal gesture is located inside the scribble, a narrow delete is used. The narrow delete is less aggressive than the wide delete and is intended to enable the user to delete small marks which overlap larger marks, without deleting the larger marks. For example, as shown in FIG. 4, a user has formed a scribble 70 over a portion of a line 74 having tick marks 72. By making a tap mark 68 inside scribble 70, only tick marks 72 contained in the scribble may be deleted. Line 74 may not be deleted. This gesture command sequence is an example of a narrow delete.

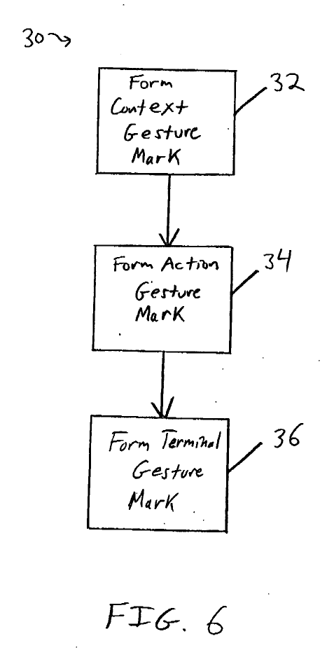

A wide delete, on the other hand, may delete the entirety of any mark that falls within the scribble gesture. For example, scribble gesture 80 in FIG. 5 may delete both line 82 and line 84 because the start and the end of the scribble gesture are not empty. An interactive version of the delete operation deletes the indicated mark(s), and then deletes any object the stylus touches until the stylus is lifted.

The paste gesture sequence aligns the matching corner of the bounding-box of the pasted contents to the crop mark corner. That is, if the drawn crop mark is the upper-left crop mark, the upper-left corner of the bounding-box is aligned with the crop mark.

The global undo operation behaves similarly to the local undo operation described above, except that the global undo operation does not use context.

Selection Action

In some embodiments, a gesture mark sequence for specifying a selection action includes specifying a context (e.g., with a lasso) and forming a terminal gesture. Additionally, a selection may be made without specifying a context by tapping twice over a single object. A selection may be canceled by tapping once anywhere where there is no object, in which case, the tap may disappear.

A rectangle is displayed around the combined bounding-boxes of all of the selected objects to signify the selection. The rectangle has a minimum size so that there is enough room to start a gesture inside the rectangle. Gesture sequences shown in the table in FIG. 3 that use specified context may instead be used in conjunction with an existing selection.

Selection Refinement Action

Once a selection has been made, further gestures can be used to add items to the selection. Additionally, gestures may be provided that apply only inside the selection rectangle for modifying the selection by deselecting, toggling, and adding marks. Further, the regular selection gesture sequence may be used to refine a selection. For example, if a lassoed region has been selected, a second lasso can be started inside the selection area and encompass an area outside the original selection. No terminal gesture is required, and the additional lasso refines the selection.

In another example, a selection may exist, and a second selection sequence is formed entirely outside of the existing selection. If the terminal gesture is inside the existing selection, then the second selection sequence may refine the existing selection; otherwise, it may deselect the old selection and make a new one.

Primitive Recognition Details

This section describes implementation details of recognition module 15. Other methods of recognizing primitives may be used in recognition module 15. The following description is not intended to be comprehensive or exclusive, rather it is intended to describe one embodiment.

As an initial step, before proceeding with other recognition processes, subpixel self-intersections are removed from a copy of the mark used for recognition.

A strokehook primitive is recognized if there are exactly three cusps in the mark and the part of the mark after the middle cusp travels back along the first part of the mark (based on the dot product being negative). The cusps may be reported by Microsoft's Tablet PC Ink SDK. Given the lists of cusps reported by Microsoft's Tablet PC Ink SDK, cusps are removed from the list until there are no two successive cusps that are closer than six pixels apart.

A tap may be recognized if a mark is made in 100 ms or less with a bounding-box of less than 15 pixels by 15 pixels, or in 200 ms or less with a bounding-box of less than 10 pixels by 10 pixels.

A pause may be detected if, during the previous 200 ms, the stylus has been in contact with the digitizing surface and no input point during that period was more than 4 pixels away from the contact point. If the pause being measured begins at the start of the mark, the threshold is increased to 400 ms. It is contemplated that the time and distance threshold be adjustable so that a user may select preferences. In other embodiments, the speed history of the writing of the mark may be incorporated so that if a user is drawing or writing something particularly slowly, false pauses are not accidentally recognized.

In one embodiment, the scribble mark has a recognition process that is based on determining whether the mark has five or more cusps including the start and end points. A triangle strip is then formed containing the set of triangles obtained by taking successive triplets of cusps (e.g., cusps 0, 1, and 2, then 1, 2, and 3, etc.). A scribble gesture is recognized as a scribble if at least 75% of the triangles each contain some part of some other object, or if both the first and last 25% of the triangles have at least one member containing some part of some other object.

A wide delete deletes everything contained at least in part by any triangle from the above triangle list. The narrow delete starts with a set of objects that the wide delete command would have used and deletes only those members of the set which are completely contained in the convex hull of the scribble. However, if no such objects exist, a normal wide delete is performed.

A lasso is recognized when a mark gets close to the starting point after first being far from the starting point, and the mark contains at least half of some object. A point on the mark is considered close to the starting point if its distance from the starting point is less than 25% of the maximum dimension of the bounding-box of the mark as a whole. A point on the mark is considered to be far from the start when its distance is more than 45% of the maximum dimension of the bounding-box. Microsoft Ink SDK is used to determine containment for marks. Containment is checked for both the mark the user drew and the mark with the same points in reverse order.

The “⊃” is recognized as a rotated “C.” A crop gesture is recognized by looking for an “l” or “L” or “7” or “c” with the appropriate rotations and with dimensional restrictions. A “Z” is recognized as a “2” or “Z.” This recognition is used as a first pass, with additional filtration to avoid objects such as a script “l” or an “l” with no distinguished cusp.

System 1, and components thereof such as input/output device 2, recognition module 15, and database 17, may be implemented using software (e.g., C, C#, C++, Java, or a combination thereof), hardware (e.g., one or more application-specific integrated circuits), firmware (e.g., electrically-programmed memory) or any combination thereof. One or more of the components of system 1 may reside on a single system (e.g., a tablet computer system), or one or more components may reside on separate, discrete systems. Further, each component may be distributed across multiple systems, and one or more of the systems may be interconnected.

Further, on each of the one or more systems that include one or more components of system 1, each of the components may reside in one or more locations on the system. For example, different portions of the components recognition module 15 or database 17 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

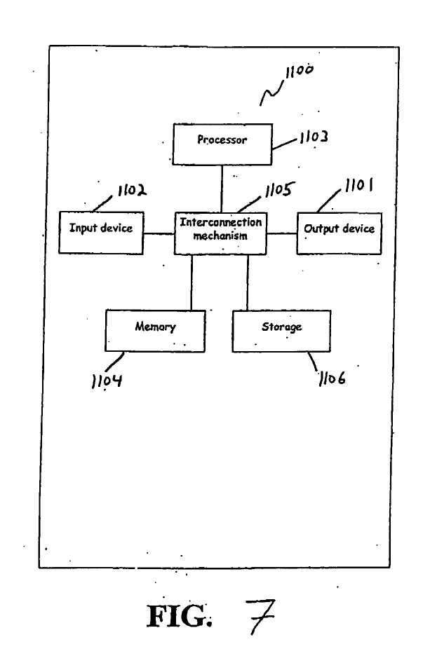

System 1 may be implemented on a computer system described below in relation to FIG. 7. System 1 is merely an illustrative embodiment of an electronic ink system. Such an illustrative embodiment is not intended to limit the scope of the invention, as any of numerous other implementations of an electronic ink system are possible and are intended to fall within the scope of the invention.

Method of System Use

One embodiment of a method 30 for a user to input action commands into an electronic ink system is illustrated in FIG. 6. In act 32, a user forms a context gesture mark to define a context for the gesture command. As described above, examples of context gesture marks include crop marks and lassos. Other context gesture marks may be used. The user may form the gesture mark on a digitizing surface or other input surface by using a pen or stylus, and contact with the surface is not necessarily required.

In act 34, the user forms an action gesture mark on the input surface to indicate an action for the gesture command. The system may not attempt to recognize the action gesture mark until after further marks are formed by the user. In other embodiments, the system may attempt to recognize the mark after it is made regardless of further marks made by the user (e.g., with recognition module 15).

In act 36, the user forms a terminal gesture mark on the input surface. The terminal gesture mark may be punctuation gesture mark, such as a tap or a double tap. The system may use the terminal gesture mark as an instruction to perform the action specified by the previously formed action gesture mark. If the action is potentially performed on a context, the system may attempt to recognize a context specification gesture mark and perform the action on the specified context.

Method 30 may include additional acts. Further, the order of the acts performed as part of method 30 is not limited to the order illustrated in FIG. 6 as the acts may be performed in other orders, and one or more of the acts of method 30 may be performed in series or in parallel to one or more other acts, or parts thereof. For example, in some embodiments, act 34 may be performed before act 32.

Method 30 is merely an illustrative embodiment of inputting action commands. Such an illustrative embodiment is not intended to limit the scope of the invention, as any of numerous other implementations of inputting action commands are possible and are intended to fall within the scope of the invention.

Method 30, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of system 1 described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described below in relation to FIG. 7, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

Various embodiments according to the invention may be implemented on one or more computer systems. These computer systems may be, for example, tablet computers. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type of computer system may be used to practice the methods and systems described above according to various embodiments of the invention. Further, the software design system may be located on a single computer or may be distributed among a plurality of computers attached by a communications network.

A general-purpose computer system according to one embodiment of the invention is configured to execute embodiments of the invention disclosed herein. It should be appreciated that the system may perform other functions, for example, executing other applications, or executing embodiments of the invention as part of another application.

For example, various aspects of the invention may be implemented as specialized software executing in a general-purpose computer system 1100 such as that shown in FIG. 7. The computer system 1100 may include a processor 1103 connected to one or more memory devices 1104, such as a disk drive, memory, or other device for storing data. Memory 1104 is typically used for storing programs and data during operation of the computer system 1100. Components of computer system 1100 may be coupled by an interconnection mechanism 1105, which may include one or more busses (e.g., between components that are integrated within a same machine) and/or a network (e.g., between components that reside on separate discrete machines). The interconnection mechanism 1105 enables communications (e.g., data, instructions) to be exchanged between system components of system 1100. Computer system 1100 also includes one or more input devices 1102, for example, a keyboard, mouse, light pen, trackball, microphone, touch screen, or digitizing surface, and one or more output devices 1101, for example, a printing device, display screen, or speaker. In addition, computer system 1100 may contain one or more interfaces (not shown) that connect computer system 1100 to a communication network (in addition or as an alternative to the interconnection mechanism 1105).

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1100 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components that that shown in FIG. 7.

Computer system 1100 may be a general-purpose computer system that is programmable using a high-level computer programming language. Computer system 1100 may be also implemented using specially programmed, special purpose hardware. In computer system 1100, processor 1103 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME), Windows XP Tablet PC or Windows XP operating systems available from the Microsoft Corporation, MAC OS System X available from Apple Computer, the Solaris Operating System available from Sun Microsystems, Linux, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service to one or more client computers, or to perform an overall task as part of a distributed system. For example, various aspects of the invention may be performed on a client-server system that includes components distributed among one or more systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages also may be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one act, the order of the acts of the method is not necessarily limited to the order in which the acts of the method are recited.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. In a system that enables a user to gesturally input electronic ink on an input surface, a method of inputting gesture commands distinguishable from other marks, comprising:
forming a context specification gesture mark on the input surface to define a context for the gesture command;
forming an action gesture mark on the input surface to indicate an action for the gesture command; and
forming a terminal gesture mark on the input surface to command the system to perform the action, the terminal gesture mark being a single gesture mark.

2. A method as in claim 1, wherein the action gesture mark is not recognized by the system until the terminal gesture mark is formed.

3. A method as in claim 1, wherein the context gesture mark, the action gesture mark and the terminal gesture mark are input to the system in the same mode.

4. A method as in claim 1, wherein the only marks that are first displayed during the method are those that correspond directly to marks formed on the display.

5. A method as in claim 1, wherein the terminal gesture mark comprises apunctuation gesture mark.

6. A method as in claim 5, wherein the terminal gesture mark is a single tap.

7. A method as in claim 1, wherein the context specification gesture mark is a flick gesture mark.

8. A method as in claim 1, where in the action gesture mark comprises one or more alpha-numeric symbols.

9. A method as in claim 1, wherein the action gesture mark is a continuation of the context specification gesture mark.

10. A method as in claim 1, wherein the terminal gesture mark is a continuation of the action gesture mark.

11. A method as in claim 10, wherein the terminal gesture mark is a pause.

12. A method as in claim 10, wherein the terminal gesture mark is a scribble.

13. A method as in claim 1, wherein the context specification gesture mark is a scribble.

14. A method as in claim 1, wherein the action gesture mark indicates a plurality of actions, and the location of the terminal gesture mark relative to the action gesture designates one action of the set of actions.

15. A method as in claim 1, wherein the context gesture mark and the action gesture mark are the same gesture mark.

16. A method as in claim 1, wherein a first type of terminal gesture mark puts the gesture command into a user-interactive mode, and a second type of terminal gesture mark puts the gesture command into a non-user-interactive mode.

17. In a system that enables a user to gesturally input electronic ink on an input surface, a method of inputting a gesture command distinguishable from other marks, comprising:
forming a scribble gesture mark on the input surface to define a context for the gesture command; and
forming a terminal gesture mark on the input surface to instruct the system to delete marks present in the context.

18. A method as in claim 17, wherein the terminal gesture mark is a single gesture mark.

19. A method as in claim 17, wherein the terminal gesture mark comprises a punctuation gesture mark.

20. A method as in claim 18, wherein the terminal gesture mark is a single tap.

21. A method as in claim 17, wherein the marks are electronic ink marks.

22. In a system that enables a user to gesturally input electronic ink on an input surface, a method of inputting a gesture command distinguishable from other marks, comprising:
in a first mode, forming an action gesture mark on the input surface to indicate a set of actions; and
in the first mode, forming a terminal gesture mark on the input surface to command the system to perform one action of the set of actions; wherein
the location of the terminal gesture mark on the input surface relative to one of the action gesture mark and a context specification gesture mark designates the one action of the set of actions.

23. A method as in claim 22, wherein the action gesture mark is recognized only after the terminal gesture mark is formed.

24. A method as in claim 22, further comprising forming a context specification gesture mark to define a context for the gesture command.

25. A method as in claim 24, wherein the context gesture mark is recognized only after the terminal gesture mark is formed.

26. A method as in claim 22, wherein the action gesture mark is a scribble.

27. A method as in claim 24, wherein the terminal gesture mark is formed on the input surface within the context.

28. A method as in claim 24, wherein the terminal gesture mark is formed on the input surface outside of the context specified by the context specification gesture mark.

29. A computer-readable medium having computer-readable signals stored thereon that define instructions that, as a result of being executed by a computer, instruct the computer to perform a method that enables a user to gesturally input, on an input surface, a gesture command distinguishable from other types of electronic ink, comprising acts of:
receiving a context specification gesture mark that defines a context for the gesture command;
receiving an action gesture mark that indicates an action for the gesture command; and
receiving a terminal gesture mark that commands the computer to perform the action, the terminal gesture mark comprising a single gesture mark.

30. A computer-readable medium having computer-readable signals stored thereon that define instructions that, as a result of being executed by a computer, instruct the computer to perform a method that enables a user to gesturally input, on an input surface, a gesture command distinguishable from other types of electronic ink, comprising acts of:
receiving a scribble gesture mark that defines a context for the gesture command; and
receiving a terminal gesture mark that commands the computer to delete marks present in the context.

31. A computer-readable medium having computer-readable signals stored thereon that define instructions that, as a result of being executed by a computer, instruct the computer to perform a method that enables a user to gesturally input, on an input surface, a gesture command distinguishable from other types of electronic ink, comprising acts of:
in a first mode, receiving an action gesture mark that indicates a set of actions; and
in the first mode, receiving a terminal gesture mark that commands the computer to perform one action of the set of actions; wherein
the location of the terminal gesture mark on the input surface relative to one of the action gesture mark and a context specification gesture mark designates the one action of the set of actions.

32. A computer-readable medium having computer-readable signals stored thereon that define instructions that, as a result of being executed by a computer, instruct the computer to perform a method that enables a user to gesturally input, on an input surface, a gesture command distinguishable from other types of electronic ink, comprising acts of:
receiving an action gesture mark that indicates an action for the gesture command; and
receiving a terminal gesture mark, wherein a first type of terminal gesture mark puts the gesture command into a user-interactive mode, and a second type of terminal gesture mark puts the gesture command into a non-user-interactive mode.
